(19) United States
(12) Patent Application Publication
(10) Pub. No.: US 2008/0253670 A1
(43) Pub. Date: Oct. 16, 2008

(54) Image Signal Re-Encoding Apparatus And Image Signal Re-Encoding Method

(75) Inventor: Hirofumi Tanigawa, Tokyo (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 11/886,874

(22) PCT Filed: Mar. 6, 2006
(86) PCT No.: PCT/JP2006/304817

§ 371 Date: Nov. 30, 2007

(30) Foreign Application Priority Data
Mar. 24, 2005 (JP) 2005-086960

(51) Int. Cl. G06T 9/00; G06K 9/36

(52) U.S. Cl. 382/238

(57) ABSTRACT

The present invention provides an image signal re-encoding apparatus and image signal re-encoding method, which reduce the amount of processing when re-encoding an image signal, and shorten the processing time required for re-encoding. An image signal re-encoding apparatus, which decodes an input image signal subjected to an encoding, and generates an output image signal by subjecting the decoded image signal to an encoding process of a system different from said encoding, the image signal re-encoding apparatus further comprising; extraction means for extracting orthogonal conversion coefficient information related to the input image signal; determination means for determining the pixel tendency of a pixel block included in the input image signal using the extracted orthogonal conversion coefficient information; prediction mode decision means for deciding an intra-frame prediction mode to be used in said encoding process in accordance with a determination result of said pixel tendency; and re-encoding means for implementing said encoding process for the decoded image signal using said intra-frame prediction mode.

### TECHNICAL FIELD

The present invention relates to an image signal re-encoding apparatus and an image signal re-encoding method, which, for example, converts a signal of a different encoding system.

### BACKGROUND ART

There are a plurality of image signal encoding systems based on various standards, such as, for example, MPEG-2 (Moving Picture Experts Group-2) and MPEG-4, and H.264, which is an ITU-T recommendation related to a video compression system.

Therefore, numerous DVD, HDD recorders and other such image signal playback apparatus comprise hardware and software for converting an image signal encoded using a prescribed system to another, different encoding system. A re-encoding apparatus or re-encoding method, which converts the encoding system of an image signal like this, decodes a first encoded data, which had been subjected to a prescribed encoding, and thereafter generates a second encoded data by subjecting this encoded data to an encoding process in accordance with another system, which differs from the above-mentioned prescribed encoding.

For example, in a process for re-encoding from MPEG-2 to MPEG-4, technology related to a re-encoding apparatus such as that described in Japanese Patent Laid-open No. 8-130743 has been disclosed. For reference sake, an image re-encoding process in such a prior art, for example, carries out intra-frame predictive encoding by reutilizing image motion vector information in an attempt to enhance encoding efficiency during re-encoding.

However, an encoding system based on H.264 or the like is a relatively new encoding system, and as such is not able to reutilize the prediction mode as-is during conventional re-encoding in an intra-frame predictive encoding process. For reference sake, the intra-frame predictive encoding process in MPEG-4 is an encoding technique, which differs from H.264 in that the MPEG-4 intra-frame predictive encoding process does not carry out predictive encoding for all pixel values like H.264, but rather only carries out prediction for a direct current (DC) component and an alternating current (AC) component subsequent to carrying out orthogonal conversion. For this reason, when carrying out re-encoding from MPEG-2 or MPEG-4 to H.264, there is no information like the above-mentioned motion vector information that can be reutilized in the intra-frame predictive encoding process.

Therefore, when carrying out re-encoding from MPEG-2 and so forth to H.264, the method that has been adopted is one in which, after carrying out encoding one time on a trial basis for all of the numerous prediction modes that exist the same as when carrying out an encoding process for a normal image signal, the prediction mode with the highest encoding efficiency from thereamong is selected and used. Thus, the problem is that during the re-encoding process, the amount of hardware and software processing pursuant to re-encoding increases, and the re-encoding process takes time.

The present invention is made to solve such problems, and has as an object the provision of an image signal re-encoding apparatus and an image signal re-encoding method, which reduces the amount of processing during image signal re-encoding, and shorten re-encoding processing time.

### DISCLOSURE OF THE INVENTION

The invention disclosed in Claim 1 is an image signal re-encoding apparatus which decodes an input image signal subjected to an encoding, and generates an output image signal by subjecting the decoded image signal to an encoding process of a system different from said encoding, comprising: extraction means for extracting orthogonal conversion coefficient information related to said input image signal; determination means for determining a pixel tendency of a pixel block included in said input image signal in accordance with said orthogonal conversion coefficient information; prediction mode decision means for deciding an intra-frame prediction mode to be used in said encoding process in accordance with a determination result of said pixel tendency; and re-encoding means for implementing said encoding process for the decoded image. signal using said intra-frame prediction mode.

Further, the invention disclosed in claim 8 is an image signal re-encoding method which decodes an input image signal subjected to an encoding, and generates an output image signal by subjecting the decoded image signal to an encoding process of a system different from said encoding the method comprising: a step of extracting orthogonal conversion coefficient information related to said input image signal; a step of determining a pixel tendency of a pixel block included in said input image signal in accordance with said orthogonal conversion coefficient information; a step of deciding an intra-frame prediction mode to be used in said encoding process in accordance with a determination result of said pixel tendency; and a step of implementing said encoding process for the decoded image signal using said intra-frame prediction mode.

### BRIEF DESCRIPTION OF THE DRAWINGS

FIG. 1 is a block diagram showing the constitution of an image signal re-encoding apparatus according to an embodiment of the present invention;

FIG. 2 is schematic diagrams showing examples of 4×4 intra-frame prediction modes;

FIG. 3 is schematic diagrams showing examples of 8×8 intra-frame prediction modes;

FIG. 4 is schematic diagrams showing examples of 16×16 intra-frame prediction modes;

FIG. 5 is a diagram illustrating a DCT coefficient base image;

FIG. 6 is a flowchart describing the processing operations in a first embodiment of the present invention;

FIG. 7 is diagrams illustrating region separations for DCT coefficient pixel components inside blocks;

FIG. 8 is diagrams illustrating concepts of orthogonal conversion coefficient analyses, and intra-frame prediction mode determinations in a first embodiment of the present invention;

FIG. 9 is a diagram showing specific examples (in the case of a horizontal prediction mode) of an intra-frame prediction mode determination according to the first embodiment of the present invention;

FIG. 10 is a diagram illustrating a concept for an intra-frame prediction process for a luminance component in accordance with the first embodiment of the present invention;

FIG. 11 is a diagram illustrating a concept for an intra-frame prediction process for color difference components in accordance with the first embodiment of the present invention;

FIG. 12 is a diagram illustrating a concept for an intra-frame prediction mode determination according to a second embodiment of the present invention;

FIG. 13 is a diagram illustrating another concept for an intra-frame prediction mode determination according to the second embodiment of the present invention; and

FIG. 14 is a flowchart describing the processing operations in the second embodiment of the present invention.

### EMBODIMENTS FOR CARRYING OUT THE INVENTION

The embodiments of the present invention will be explained below.

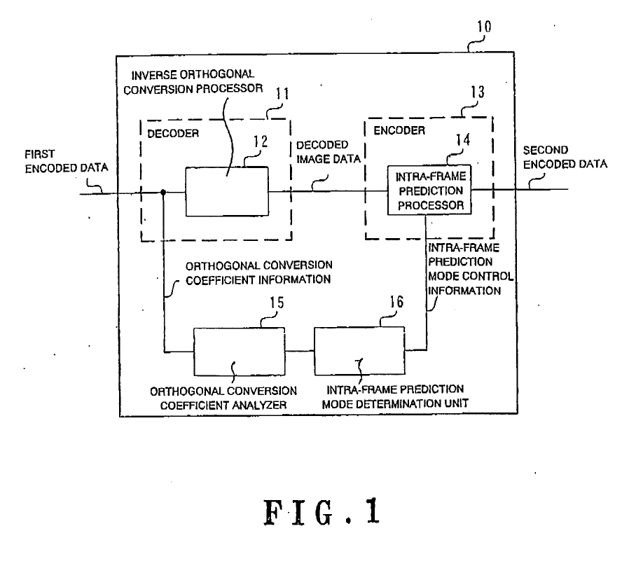

FIG. 1 shows an image signal re-encoding apparatus 10, which is a first embodiment of the present invention.

A “first encoded data”, which is the input signal of this apparatus, is an image signal subjected to an encoding process of a format, which utilizes so-called orthogonal conversion, such as DCT (Discrete Cosine Transform), without using intra-frame predictive encoding, and, for example, is an MPEG-1 or MPEG-2, or JPEG encoded signal. Also, a “second encoded data”, which is the output of this apparatus, is an image signal, which has been subjected to an encoding process, such as H.264, for example, which unlike the above signal, is an encoding system that utilizes intra-frame predictive encoding.

In FIG. 1, a decoder 11 is the part, which performs decoding by cancelling the encoding carried out for the first encoded data. That is, an inverse orthogonal conversion processor 12 comprised in the decoder 11 performs an inverse orthogonal conversion process on the first encoded data, decodes the previous image signal, which had been subjected to DCT compression encoding, and supplies this decoded image data to an encoder 13. Further, the decoder 11 extracts “orthogonal conversion coefficient information”, which is comprised in the first encoded data, and which is related to the DCT coefficients at the time of orthogonal conversion, and supplies this orthogonal conversion coefficient information to an orthogonal conversion coefficient analyzer 15 (called the “analyzer 15” hereinafter).

The analyzer 15 is the part, which analyzes the pixel tendency of a block of pixels comprised in the decoded image data, based on this orthogonal conversion coefficient information.

An intra-frame prediction mode determination unit 16 (called the “determination unit 16” hereinafter) is the part, which determines the intra-frame prediction mode to be used in the intra-frame prediction processor 14, which will be explained hereinbelow (called the “prediction unit 14” hereinafter), in accordance with the pixel tendency of the analysis result by the analyzer 15. Therefore, the intra-frame prediction mode determined by the determination unit 16 is supplied from the determination unit 16 to the prediction unit 14 inside an encoder 13 as “intra-frame prediction mode control information”.

The encoder 13 is the part, which performs an encoding process according to an encoding system, such as H.264, for example, for the decoded image data supplied from the decoder 11. In this encoding process, the prediction unit 14 inside the encoder 13 strives to shorten encoding process time when generating the second encoded data by executing an intra-frame prediction process during encoding, based on the intra-frame prediction mode determined by the determination unit 16.

Next, the operation of the image signal re-encoding apparatus 10 of FIG. 1 will be explained.

First, when the encoding system of the second encoded data is H.264, the type of intra-frame prediction mode used by the prediction unit 14 inside the encoder 13 in the case of the luminance component is one of three modes:

[A] 4×4 intra-frame prediction mode

[B] 8×8 intra-frame prediction mode

[C] 16×16 intra-frame prediction mode

However, the “8×8 intra-frame prediction mode” of [B] cannot be used in the Baseline-Profile, Main-Profile and Extended-Profile of H.264.

Meanwhile, there is only one prediction mode for the color difference component:

[B] 8×8 intra-frame prediction mode

The properties of the respective prediction modes of the above-mentioned [A] through [C] will be explained next.

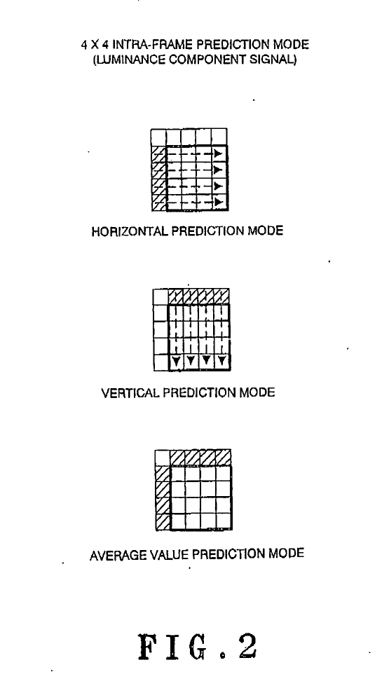

First, for the “4×4 intra-frame prediction mode” of [A], there are nine modes in all in accordance with the prediction processing modes thereof, but of these, the present invention uses the three modes of “horizontal prediction mode”, “vertical prediction mode” and “average value prediction mode” as shown in FIG. 2.

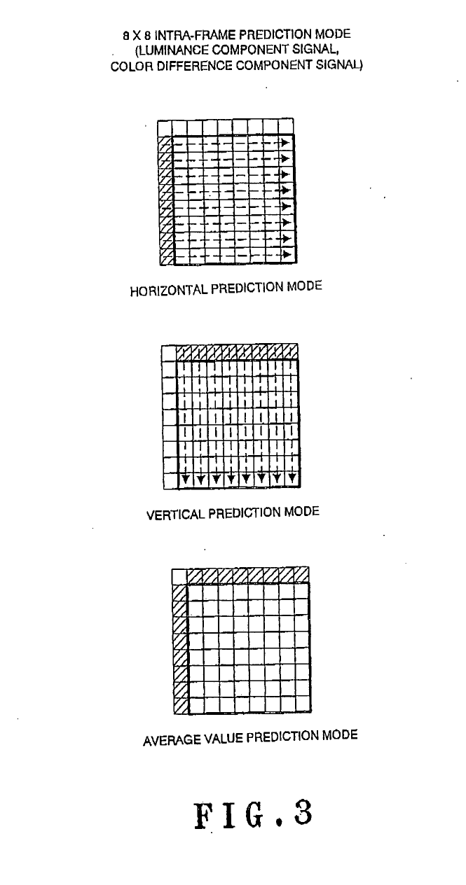

In the case of the “8×8 intra-frame prediction mode” of [B] as well, the same nine modes as mentioned above exist, but of these, the present invention uses the three modes of “horizontal prediction mode”, “vertical prediction mode” and “average value prediction mode” as shown in FIG. 3.

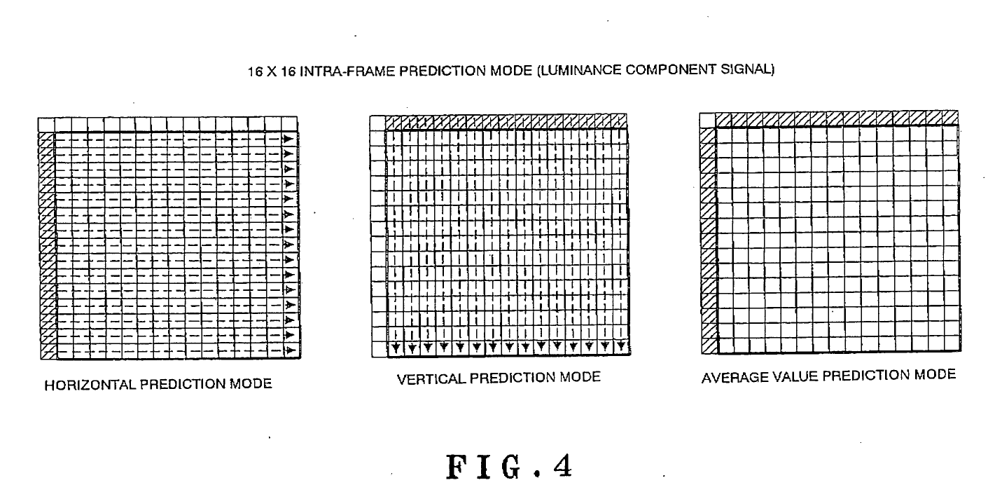

Furthermore, in the case of the “16×16 intra-frame prediction mode” of [C], there are a total of four modes, but, as shown in FIG. 4, the present invention uses the three prediction modes of horizontal, vertical and average value the same as in the two examples described hereinabove. Furthermore, details of the respective horizontal, vertical and average value prediction modes will be explained in the embodiments of the present invention described hereinbelow.

Next, the characteristic features of the DCT coefficients comprised in the orthogonal conversion coefficient information extracted by the decoder 11 and supplied to the analyzer 15 in FIG. 1 will be explained.

In MPEG, H.264 and other such standards, which handle the YUV 4:2:0 format, the numerical representation criteria for color, image signal processing is carried out by dividing a single frame into macro-blocks comprising prescribed numbers of pixels. For reference sake, the size of one macro-block is 16×16 pixels for a luminance component Y, and 8×8 pixels, respectively, for the color difference components Cb, Cr.

DCT processing during encoding is generally carried out in blocks of 8×8 pixels each. Therefore, the 16×16 pixel block region of a macro-block's luminance component is divided into four 8×8 pixel blocks, and a DCT process is carried out for each of these blocks.

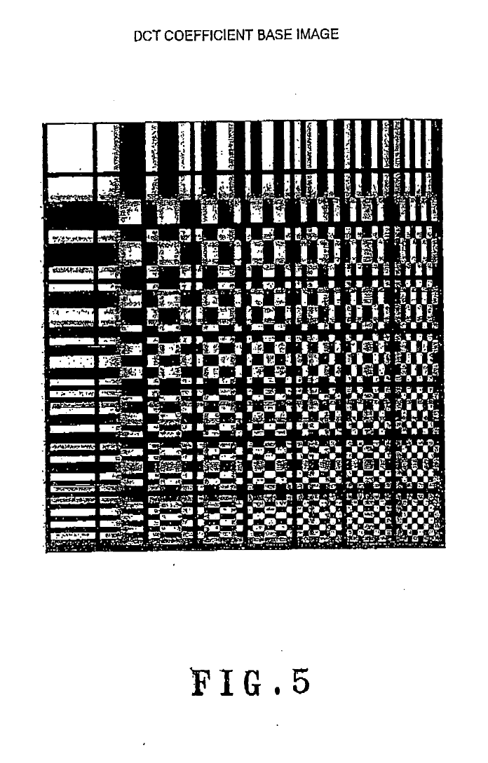

The DCT process harmonically analyzes the spatial frequencies comprising an original image from the low-frequency components to the high-frequency components. Therefore, when this process is carried out, the characteristic feature is that the low-frequency components (the pattern where spatial frequency is low, that is, the pattern in which there is little change) cluster in the upper-left of the block, and the high-frequency components (the pattern where the spatial frequency is high, that is, the pattern in which there is a lot of change) cluster in the lower-right of the block, as in the schematic diagram of a base image shown in FIG. 5.

Also, the DCT coefficients determined by the DCT process are characterized in that the horizontal components of the image cluster in the left side of the block, and the vertical components of the image cluster at the top of the block, the same as the base image schematic diagram of FIG. 5. Furthermore, the DCT coefficients of upper left corner in the block indicate the DC components of the image, and the values thereof indicate the average value of the respective pixel values in the original block.

MPEG and other such code compression processes carry out efficient compression encoding for an image signal by saving the low-frequency component information of an image, which is easy for the human eye to recognize, and deleting the difficult-to-recognize high-frequency component information. To realize this goal, the low-frequency components and high-frequency components of the DCT coefficients are separated, and a DCT process, which exhibits the tendency to cluster in prescribed regions, is used.

The gist of the present invention lies in the fact that the determination of a prediction mode to be used in the intra-frame prediction process during re-encoding is carried out efficiently in a short period of time by making use not only of the characteristic feature that an image's low-frequency components and high-frequency components are separated and clustered in the DCT coefficients, but also of the characteristic features that the horizontal components and vertical components thereof are also separated and clustered, and the DC component thereof is the average value of the respective pixel values inside the block.

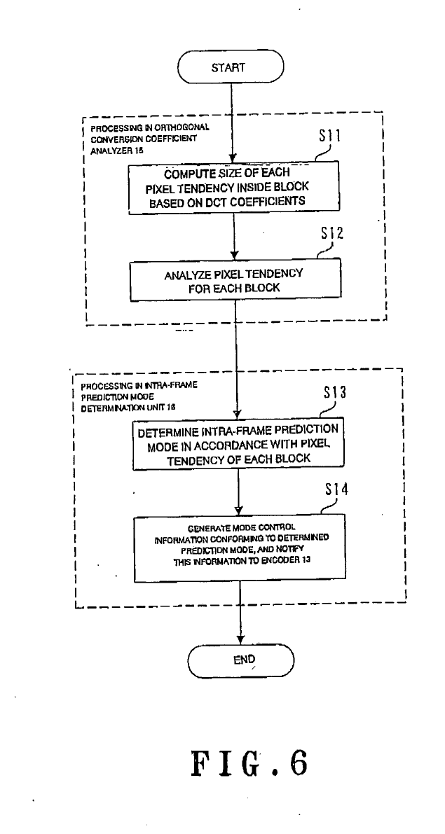

Next, the process up to the determination of a prescribed intra-frame prediction mode in the prediction unit 16 based on the analysis result of the analyzer 15 is described in the flowchart of FIG. 6.

First, the analyzer 15 carries out region separation of the respective pixel tendencies of the horizontal components, vertical components, complex components, and DC components in each block based on the characteristic features of the DCT coefficients comprised in the orthogonal conversion coefficient information supplied from the decoder 11. Then, the analyzer 15 computes the sum of the absolute values of the DCT coefficients in each of the respective regions, and computes the sizes of the respective pixel tendencies (Step S11).

That is, the pixel tendency referred to here can be defined as a numerical parameter obtained for the respective luminance component and color difference component blocks by performing various arithmetic and logical processes on values associated with the DCT coefficients related to these blocks.

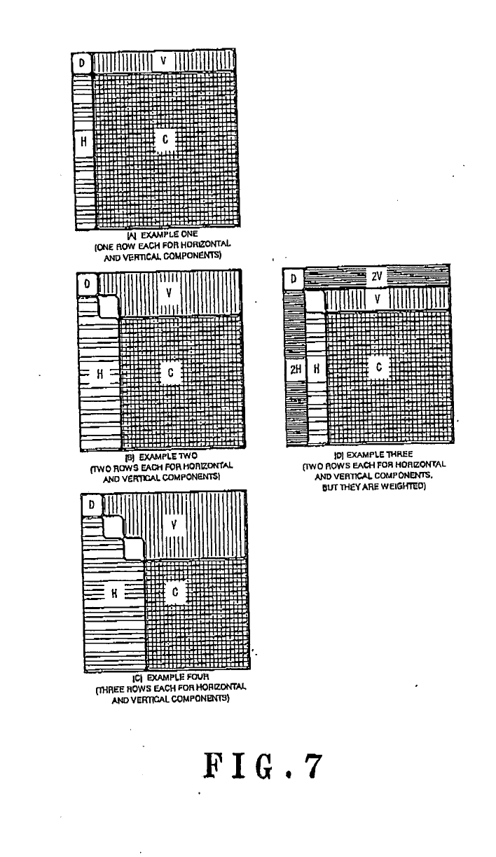

For reference sake, methods for separating a block into regions by respective pixel tendencies for the horizontal components and vertical components, respectively, as shown in FIG. 7, for example, include:

(1) Method that uses one row for each component per block (FIG. 7A)

(2) Method that uses two rows for each component per block (FIG. 7B)

(3) Method that uses three rows for each component per block (FIG. 7C)

(4) Method that weights regional separation to coincide with the characteristic intensity of each component (FIG. 7D)

In the next Step S12, the analyzer 15 analyzes which tendencies the respective blocks of pixels are in—horizontal, vertical, planar or complex—based on the sizes of the respective calculated pixel tendencies. Furthermore, there are various methods for analyzing the pixel tendency of each block, a number of examples of which will be given hereinbelow.

Now, in Step S11 of FIG. 6, when the sizes of the respective regionally separated and computed horizontal components, vertical components and complex components are placed in the horizontal component H, the vertical component V and the complex component C, a variety of pixel tendency analysis methods like those below are possible. Furthermore, needless to say, the methods shown below simply cite examples of analysis methods, and the embodiments of the present invention are not limited to these examples.

### First Analysis Method

(1) If a prescribed threshold>(H+V+C), the pixel tendency is determined to be a “planar tendency”.

(2) If H>(H+V+C)×(½), the pixel tendency is determined to be a “horizontal tendency”.

(3) If V>(H+V+C)×(½), the pixel tendency is determined to be a “vertical tendency”.

(4) When none of the above-mentioned (1) through (3) apply, the pixel tendency is determined to be a “complex tendency”.

### Second Analysis Method

(1) If a prescribed threshold>(H+V+C), the pixel tendency is determined to be a “planar tendency”.

(2) If H>(H+V+C)×(⅔), the pixel tendency is determined to be a “horizontal tendency”.

(3) If V>(H+V+C)×(⅔), the pixel tendency is determined to be a “vertical tendency”.

(4) When none of the above-mentioned (1) through (3) apply, the pixel tendency is determined to be a “complex tendency”.

### Third Analysis Method

(1) If a prescribed threshold>(H2+V2+C2), the pixel tendency is determined to be a “planar tendency”.

(2) If H2>(H2+V2+C2)×(½), the pixel tendency is determined to be a “horizontal tendency”.

(3) If V2>(H2+V2+C2)×(½), the pixel tendency is determined to be a “vertical tendency”.

(4) When none of the above-mentioned (1) through (3) apply, the pixel tendency is determined to be a “complex tendency”.

The pixel tendency for each block obtained in Step S12 is notified to the determination unit 16 from the analyzer 15, and in the next Step S13, the determination unit 16 determines an intra-frame prediction mode, which conforms to the pixel tendency of each block.

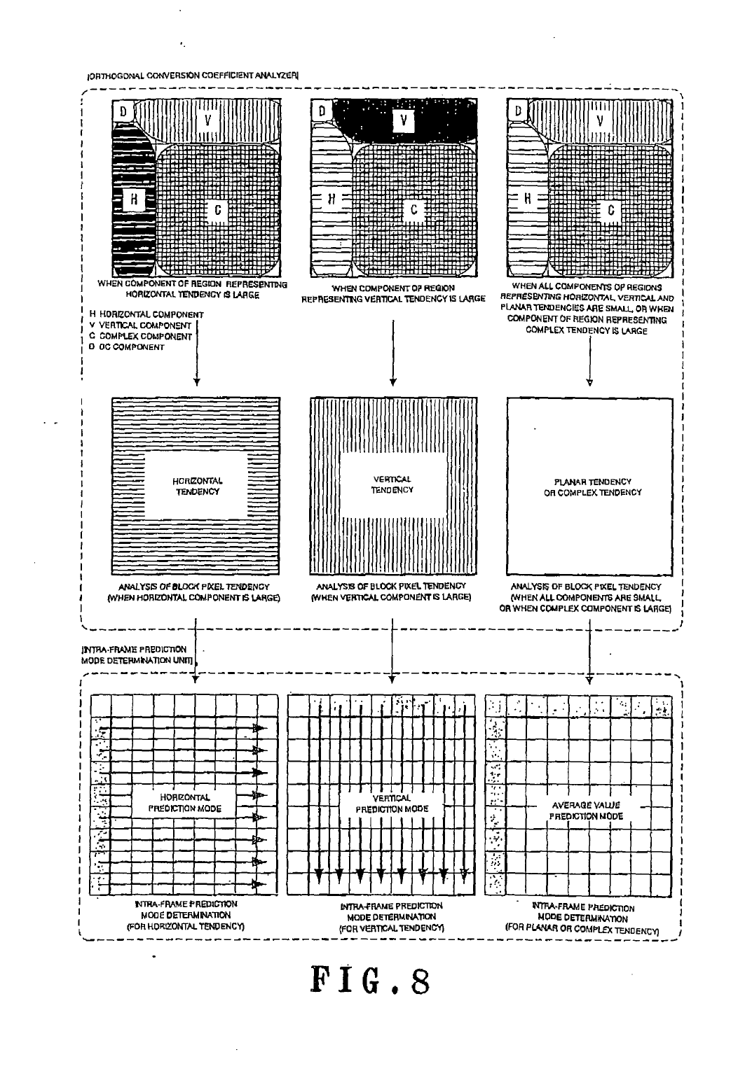

As shown in FIG. 8, if the pixel tendency determined by the analyzer 15 is a horizontal tendency, the intra-frame prediction mode determination method determines this intra-frame prediction mode to be a horizontal prediction mode, and if the pixel tendency determined by the analyzer 15 is a vertical tendency, the intra-frame prediction mode determination method determines this intra-frame prediction mode to be a vertical prediction mode. Further, if the pixel tendency is a planar tendency, the intra-frame prediction mode determination method determines the intra-frame prediction mode to be an average value prediction mode, and if the pixel tendency is a complex tendency, the intra-frame prediction mode determination method similarly determines the intra-frame prediction mode to be an average value prediction mode.

Furthermore, when the pixel tendency is a complex tendency, no conspicuous difference will occur in the encoding efficiency of the encoder 13 no matter which intra-frame prediction mode is used. Therefore, when it has been analyzed in Step S12 that the pixel tendency is a complex tendency, for example, a determination method, which employs the horizontal prediction mode or vertical prediction mode as the intra-frame prediction mode can also be used instead of the average value prediction mode. Further, instead of carrying out a DCT coefficient-based determination process, the prediction mode to be used can also be determined on the basis of an ordinary retrieval process. Or, it is also possible to employ the same determination mode as that of an adjacent block, which is either above or below this block, for which the prediction mode has already been determined.

In Step S13, when the determination unit 16 determines an intra-frame prediction mode, which conforms to the pixel tendencies of each block, the determination unit 16 generates intra-frame prediction mode control information based on this result, and notifies this information to the prediction unit 14 inside the encoder 13 (Step S14).

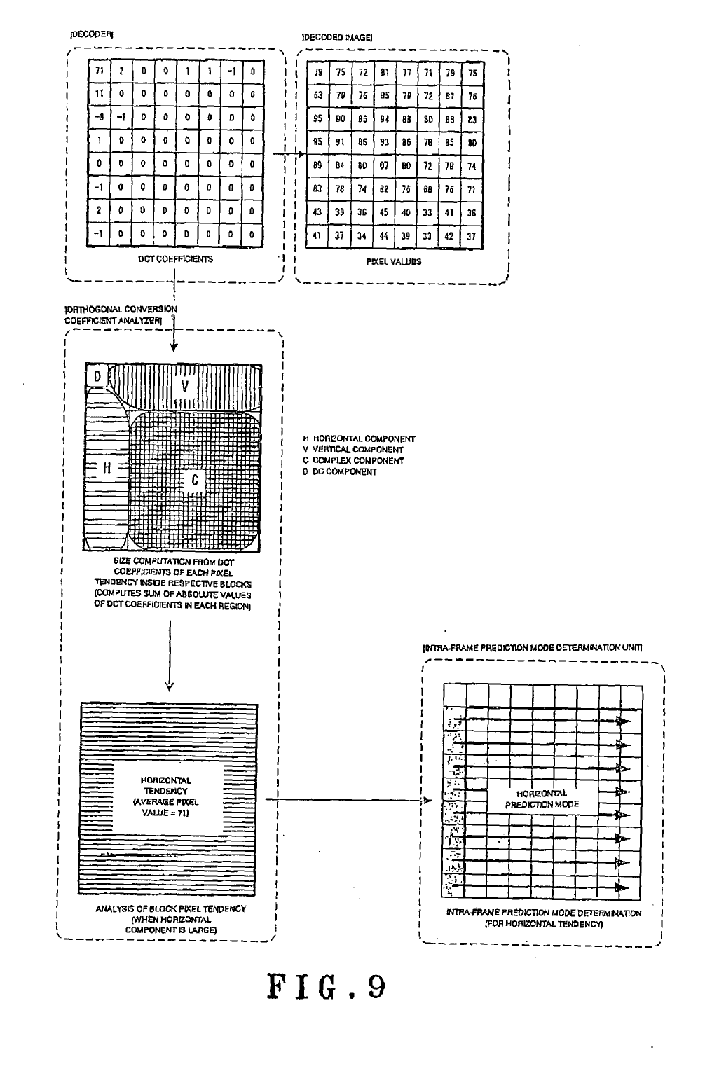

Furthermore, FIG. 9 shows a specific example of the processing from DCT coefficient analysis to intra-frame prediction mode determination explained hereinabove.

For reference sake, in FIG. 9, the method employed for separating a block into regions by pixel tendency is one, which uses two rows inside the block for each of the horizontal component and the vertical component. In accordance with the respective separated regions for the horizontal component (H), vertical component (V), direct current component (D) and complex component (C) shown in the middle of FIG. 9, determining the sum of the absolute values of the DCT coefficients in each of the respective regions produces D=71 for the direct current component, H=25 for the horizontal component, V=5 for the vertical component, and C=0 for the complex component.

Therefore, if, for example, the above-described [First Analysis Method] is used as the pixel tendency determination method, the equation becomes

H=25>(H+V+C)×(½)=15

thereby satisfying relational expression (2) of the [First Analysis Method], and the analyzer 15 determines that the pixel tendency of the block is the horizontal tendency.

Then, the determination unit 16 receives the determination result from this analyzer 15, and determines that the intra-frame prediction mode thereof is the horizontal prediction mode.

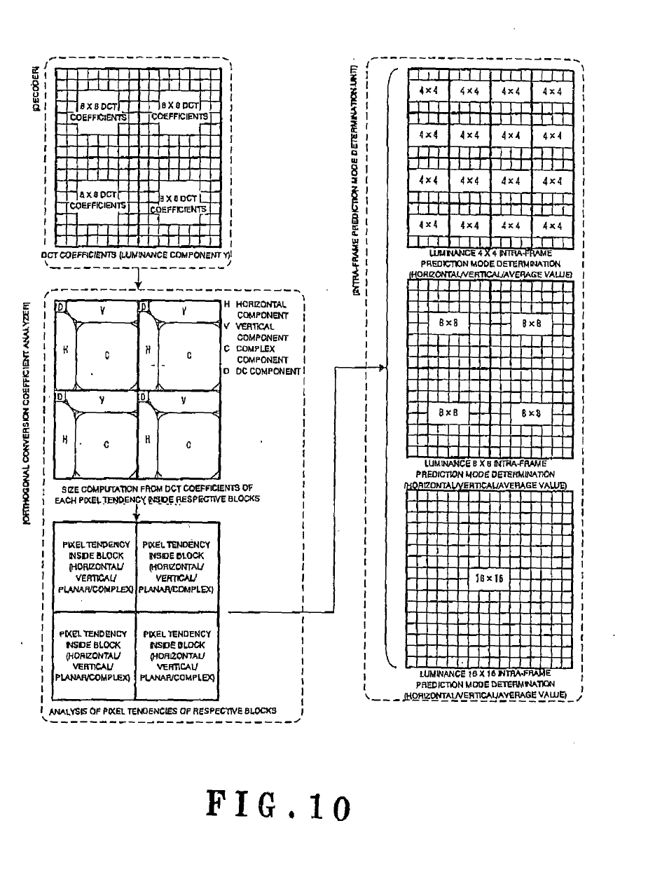

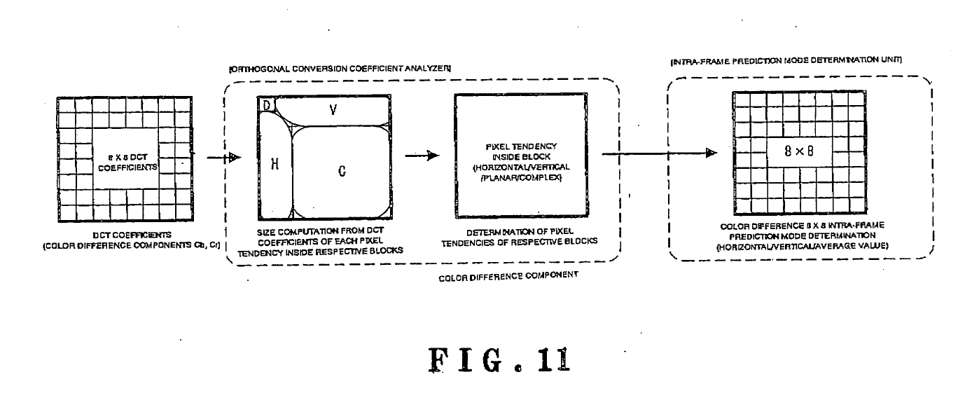

Furthermore, in this embodiment, FIG. 10 shows a conceptual view of up to the determination of the intra-frame prediction mode for the luminance component block, and FIG. 11 shows a conceptual view of up to the determination of the intra-frame prediction mode for the color difference component block.

As explained hereinabove, this embodiment is an image signal re-encoding apparatus, which decodes an input image signal subjected to an encoding, and generates an output image signal by subjecting the decoded image signal to an encoding process of a system different from the encoding, and comprises a decoder 11, which comprises extraction means for extracting orthogonal conversion coefficient information related to the above-mentioned input image signal: an analyzer 15, which is equivalent to determination means for determining, based on the above-mentioned orthogonal conversion coefficient information, the pixel tendency of a pixel block comprising the above-mentioned input image signal; a determination unit 16, which is equivalent to prediction mode decision means for deciding an intra-frame prediction mode for the above-mentioned different system encoding process In accordance with the above-mentioned pixel tendency determination result; and an encoder 13, which is equivalent to re-encoding means for carrying out the above-mentioned different system encoding process for the above-mentioned decoded image signal using an intra-frame prediction mode based on the above-mentioned decision.

By adopting the above-mentioned constitution, the image signal re-encoding apparatus based on this embodiment analyzes the intensity of the respective horizontal component, vertical component, direct current component, and complex (high-frequency) component for the DCT coefficients obtained during the decoding of the input image signal, and determines which tendency, the horizontal, vertical, planar or complex tendency, will be the image block pixel tendency. Then, based on this pixel tendency analysis result, the image signal re-encoding apparatus of this embodiment determines the prediction mode of the intra-frame predictive encoding process for the re-encoding process.

Consequently, in the image signal re-encoding apparatus based on this embodiment, it is possible to reduce the amount of processing as well as the processing time required for re-encoding, and the image signal re-encoding apparatus can also be made more compact and less expensive.

Next, an image signal re-encoding apparatus, which is a second embodiment of the present invention, will be explained.

Furthermore, since the constitution of the image signal re-encoding apparatus according to this embodiment is the same as that of the first embodiment, an explanation of this constitution will be omitted. That is, the second embodiment only differs from the first embodiment in terms of the processing operations of the analyzer 15, determination unit 16 and decoder 13 of the image signal re-encoding apparatus 10 shown in FIG. 1.

First, it is supposed that the results of analysis of pixel tendencies based on DCT coefficients by the analyzer 15 resulted in all four of the luminance blocks inside a macro-block having the same pixel tendency, that is, the horizontal tendency, vertical tendency or planar tendency.

In a case like this, for example, rather than using a 4×4 intra-frame prediction mode or an 8×8 intra-frame prediction mode for each of the respective blocks, there are times when using a 16×16 intra-frame prediction mode to carry out intra-frame predictive encoding in one operation in the re-encoding process achieves better encoding efficiency.

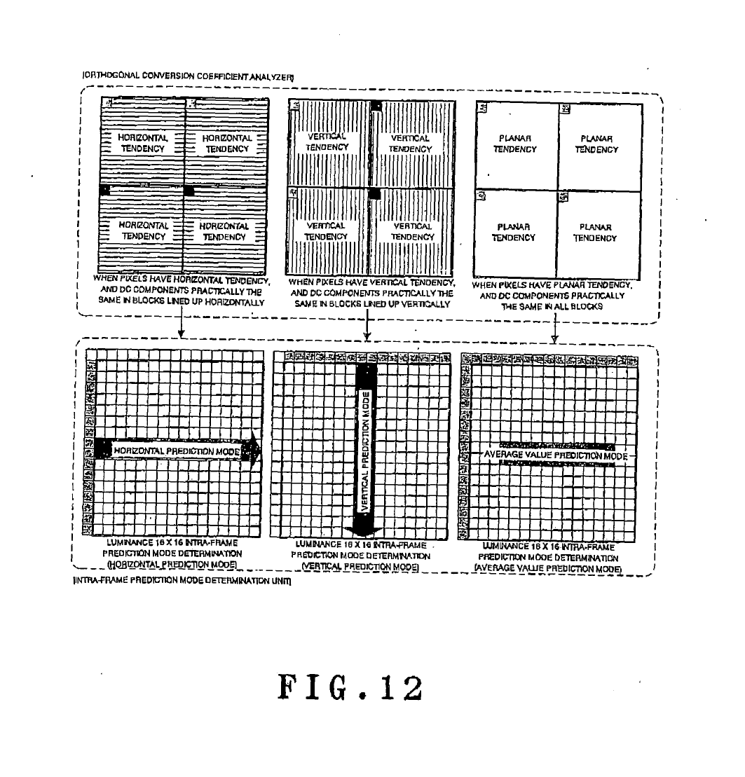

Accordingly, in this embodiment, when all four blocks have horizontal tendencies, and, in addition, the values of the direct current components in the blocks lined up in the horizontal direction are practically the same as shown in FIG. 12, the determination unit 16 determines the intra-frame prediction mode to be the 16×16 horizontal prediction mode.

Further, when all four blocks have vertical tendencies, and, in addition, the values of the direct current components in the blocks lined up in the vertical direction are practically the same, the determination unit 16 determines the intra-frame prediction mode to be the 16×16 vertical prediction mode.

Conversely, when all four blocks have planar tendencies, and, in addition, the values of the direct current components in all four blocks are practically the same, the determination unit 16 determines the intra-frame prediction mode to be the 16×16 average value prediction mode.

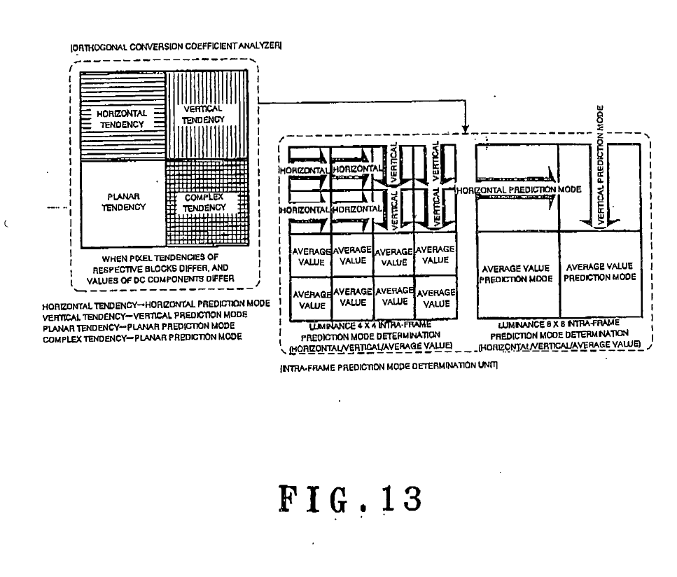

Furthermore, in cases other than the three conditions mentioned above, for example, a 4×4 intra-frame prediction mode or 8×8 intra-frame prediction mode can be used for each of the respective blocks as shown in FIG. 13 rather than using the 16×16 intra-frame prediction mode.

Also, in this embodiment, as methods for making proper use of the respective 16×16, 8×8, and 4×4 intra-frame prediction modes, the 16×16 intra-frame prediction mode can be used when the image is either simple or planar, and the 4×4 intra-frame prediction mode can be used when the image is complex. Encoding efficiency can be enhanced by making proper use of the intra-frame prediction modes like this.

In this case, as a method for determining whether an image is simple or complex, the total value (for example, the sum of the absolute values) of the DCT coefficients is computed, and if this total is small, the image is determined to be simple, and the 16×16 intra-frame prediction mode is used. Conversely, if this total is large, the image is determined to be complex, and the 4×4 intra-frame prediction mode is used. Furthermore, if the total value of the DCT coefficients is moderate, the complexity of the frame is also determined to be moderate, and the 8×8 intra-frame prediction mode is used.

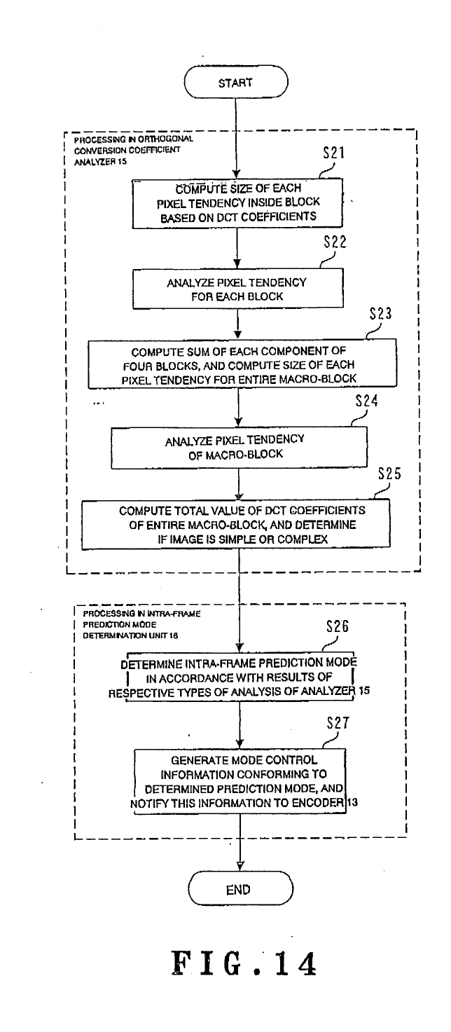

FIG. 14 shows a process flowchart for this embodiment.

First, in Step 21 of this figure, the analyzer 15, based on the respective DCT coefficient characteristics for the four luminance blocks inside the macro-block, subjects each block to region separation processing for the pixel tendencies of each of the horizontal components, vertical components, complex components, and direct current components. Then, the analyzer 15 calculates the sizes of the respective pixel tendencies by computing the sum of the absolute values of the DCT coefficients for each of the respective regions.

Next, in Step S22, the analyzer 15 analyzes the pixel tendencies for each of the respective blocks, and determines a horizontal tendency, vertical tendency, planar tendency, or complex tendency in accordance with the results of this analysis the same as in the first embodiment.

Next, to analyze the pixel tendency of the entire macro-block, the analyzer 15 computes the sums of each of the respective horizontal, vertical and complex components of the four blocks, and computes the sizes of the respective pixel tendencies of the entire macro-block (Step S23).

Next, in Step S24, the analyzer 15 analyzes which of the horizontal, vertical, planar or complex tendencies is the pixel tendency for the entire macro-block based on the sizes of the respective calculated pixel tendencies.

Furthermore, in Step S25, the analyzer 15 determines if the image is simple or complex by calculating the total value of the DCT coefficients of the entire macro-block.

The determination unit 16 determines the most appropriate intra-frame prediction mode by using the simple/complex image determination according to the DCT coefficient total value, the pixel tendency determination for the entire macro-block, and the pixel tendencies for each of the respective blocks explained hereinabove (Step S26).

In this embodiment, the 16×16 intra-frame prediction mode determination is made more efficiently by making use the characteristic feature by which the direct current component of the DCT coefficients denotes the average value of the pixel values inside a block. That is, even if the pixel tendencies of the four blocks making up the macro-block are the same, when the direct current component of the DCT coefficients differs greatly for each block, the average of the pixel values in the respective blocks will also differ greatly, meaning that the 16×16 intra-frame prediction mode will not be effective in such cases. In other words, it is possible to efficiently determine when the 16×16 intra-frame prediction mode can be used by checking the direct current component of the DCT coefficients.

Further, in this embodiment, the determination as to which of the respective 16×16, 8×8, or 4×4 intra-frame prediction modes to use is efficiently carried out by using the total value of the DCT coefficients to determine whether an image is simple or complex. That is, the alternating current component of the DCT coefficients denotes the degree of fluctuation in the characteristic features corresponding to a base image relative to the average value of the pixels inside a block denoted by the direct current component thereof. Therefore, computing the total value of the DCT coefficients makes it possible to determine the extent to which the pixels inside either a block or a macro-block are complex or simple. Then, it is possible to determine, based on the result of a complexity determination such as this, just how much encoding efficiency will be improved by using the respective intra-frame prediction modes.

1. An image signal re-encoding apparatus which decodes an input image signal subjected to an encoding, and generates an output image signal by subjecting the decoded image signal to an encoding process of a system different from said encoding, comprising:
an extraction part for extracting orthogonal conversion coefficient information related to said input image signal;
a determination part for determining a pixel tendency of a pixel block included in said input image signal in accordance with said orthogonal conversion coefficient information;
a prediction mode decision part for deciding an intra-frame prediction mode to be used in said encoding process in accordance with a determination result of said pixel tendency; and
a re-encoding part for implementing said encoding process for the decoded image signal using said intra-frame prediction mode.

2. The image signal re-encoding apparatus according to claim 1, wherein said determination part separates said pixel block into prescribed regions, calculates a size of a pixel tendency, for each divided region, in use of said orthogonal conversion coefficient information, and determines the pixel tendency of the pixel block based on the size of the pixel tendency of each calculated region.

3. The image signal re-encoding apparatus according to claim 2, wherein each of said prescribed regions is a direct current component region, horizontal component region, vertical component region, and complex component region of said orthogonal conversion coefficient information.

4. The image signal re-encoding apparatus according to claim 3, wherein said determination part determines the pixel tendency of the pixel block to be any of a horizontal tendency, vertical tendency, planar tendency, and complex tendency in accordance with the size of the pixel tendency of each region.

5. The image signal re-encoding apparatus according to claim 4, wherein said prediction mode decision part sets said intra-frame prediction mode to a horizontal prediction mode when the pixel tendency of the pixel block is the horizontal tendency.

6. The image signal re-encoding apparatus according to claim 4, wherein said prediction mode decision part said intra-frame prediction mode to a vertical prediction mode when the pixel tendency of the pixel block is the vertical tendency.

7. The image signal re-encoding apparatus according to claim 4, wherein said prediction mode decision part sets said intra-frame prediction mode to an average value prediction mode when the pixel tendency of the pixel block is either the planar tendency or the complex tendency.

8. An image signal re-encoding method which decodes and input image signal subjected to an encoding, and generates an output image signal by subjecting the decoded image signal to an encoding process of a system different from said encoding, the method comprising:
a step of extracting orthogonal conversion coefficient information related to said input image signal;
a step of determining a pixel tendency of a pixel block included in said input image signal in accordance with said orthogonal conversion coefficient information;
a step of deciding an intra-frame prediction mode to be used in said encoding process in accordance with a determination result of said pixel tendency; and
a step of implementing said encoding process for the decoded image signal using said intra-frame prediction mode.
